(19) United States
(12) Patent Application Publication
(10) Pub. No.: US 2005/0198875 A1
(43) Pub. Date: Sep. 15, 2005

(54) Foldable sign

(76) Inventor: Lenny Herrin, Jenkintown, PA (US)

Correspondence Address: AKIN GUMP STRAUSS HAUER & FELD L.L.P., ONE COMMERCE SQUARE, 2005 MARKET STREET, SUITE 2200, PHILADELPHIA, PA, 19103, US

(21) Appl. No.: 11/076,180

(22) Filed: Mar. 9, 2005

Related U.S. Application Data
(60) Provisional application No. 60/552,626, filed on Mar. 12, 2004.

(51) Int. Cl. G09F 1/00; G09F 17/00; G09F 21/02

(52) U.S. Cl. 40/124.13; 40/586

(57) ABSTRACT

A foldable sign for providing a visual indication to an observer including a body having a first edge and a second edge opposite the first edge. A first handle hole proximate the first edge and a second handle hole proximate the second edge. At least one fold line in the body between the first and second handle holes. The fold line is integral with the body and the body is foldable along the fold line between a storage position and an operating position. The first edge is positioned proximate the second edge in the storage position.

### BACKGROUND OF THE INVENTION

Signs including slogans, logos, political messages and like items printed on their faces have been utilized for any many years. Printed signs are commonly transported to sporting events, political rallies or other locations where the user totes the sign with them at all times. The signs have commonly been printed on a flat, generally rigid rectangular sheet of cardboard. These flat cardboard signs are often inconvenient to carry and are easily ripped, torn or damaged, specifically if and/or when they become wet. In addition, printing on these flat cardboard signs may become damaged when the sign is exposed to water or scratched during use. The simple grasping of these signs may damage or tear the sign when they are carried or shown by a user. Planar plastic corrugated political signs with two metal rods attached for display in a lawn or public area to identify a political candidate that the user is supporting have also been developed.

However, the above-discussed planar signs generally do not include handles or alternate mechanisms that a user can easily grasp to display or transport the sign or a simple method for collapsing the sign for storage or transportation. Further, these prior art signs do not include a collectible or marketing portion that is relatively small and may be removed from the sign for later use. The removable portion may be utilized by a collector or marketer to provide a collectible, advertisement or other item that may be removed by a purchaser for later use.

### BRIEF SUMMARY OF THE INVENTION

Briefly stated, a preferred embodiment of the present invention is directed to a foldable sign for providing a visual indication to an observer. The foldable sign includes a body having a first edge and a second edge opposite the first edge. A first handle hole is located proximate the first edge and a second handle hole is located proximate the second edge. At least one fold line is located in the body between the first and second handle holes. The fold line is integral with the body. The body is foldable along the fold line between a storage position and an operating position. The first edge is positioned proximate the second edge in the storage position.

In another aspect, a preferred embodiment of the present invention is directed to a foldable sign for providing a visual indication to an observer. The foldable sign includes a body and a pair of handles cut in the body at opposite sides of the body. At least one fold line is located in the body permitting the body to be folded over upon itself along the at least one fold line into a storage position. The at least one fold line is comprised of a living hinge and the body is constructed of a polymeric material.

### BRIEF DESCRIPTION OF THE SEVERAL VIEWS OF THE DRAWINGS

The following detailed description of the preferred embodiments of the present invention will be better understood when read in conjunction with the appended drawings. Presently preferred embodiments are shown in the drawings for the purpose of illustrating the invention. It is understood, however, that the invention is not limited to the precise arrangements and instrumentalities shown. In the drawings:

FIG. 1 is a top perspective view of a foldable sign in accordance with a first preferred embodiment of the present invention;

FIG. 2 is a top plan view of the foldable sign of FIG. 1 in an operating position;

FIG. 3 is a top plan view of the foldable sign of FIG. 1 in a storage position;

FIG. 4 is a top plan view of the foldable sign of FIG. 1 in an operating position with a slogan on a front face and a punch tab in a handle hole; and

FIG. 5 is a top plan view of a foldable sign in accordance with a second preferred embodiment of the present invention.

### DETAILED DESCRIPTION OF THE INVENTION

Certain terminology is used in the following description for convenience only and is not limiting. The words, “right,” “left,” “lower” and “upper” designate directions in the drawings to which reference is made. The words “inwardly” and “outwardly” refer to directions toward and away from, respectively, the geometric center of the foldable sign and designated parts thereof. The terminology includes the words above specifically mentioned, derivatives thereof and words of similar import. Additionally, the word “a,” as used in the specification, means at least one.

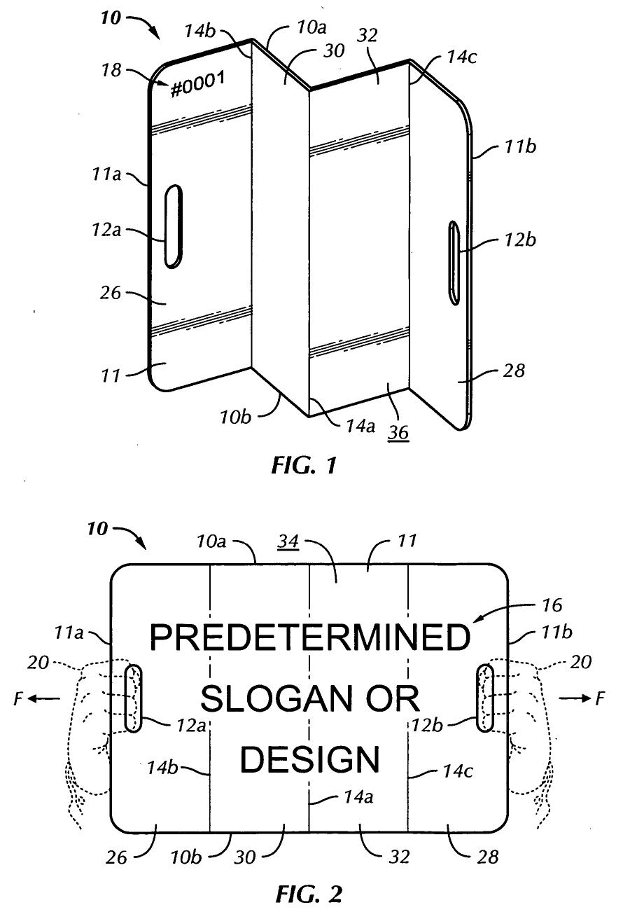

Referring to FIGS. 1-4, in a first preferred embodiment, a foldable sign 10 for providing a visual indication to an observer includes a body 11 having a first edge 11a and a second edge 11b. The body 11 of the foldable sign 10 has a generally thin, rectangular shape and includes top and bottom edges 10a, 10b in addition to the first and second edges 11a, 11b. Corners of the body 11 are preferably rounded to eliminate pointed corners on the sign 10 such that a user is less likely to be scratched by the corners while using the foldable sign 10.

In the preferred embodiments, the body 11 of the foldable sign 10 is constructed of a polymeric sheet material. The polymeric sheet material is preferably light weight, able to take on various colors, able to accept printing and is durable. The body 11 is most preferably constructed of a material such as polypropylene, polyethylene, polyvinyl chloride (PVC) and/or polyethylene terephthalate (PET). These materials are particularly suited for the foldable sign 10 due to their durability, light weight, adaptability, strength and ability to take on and withhold printing. In addition, these materials are relatively easy to form into the general shape of the body 11. The body 11 is not limited to these materials and may be constructed in nearly any material that is able to take on the general shape of the body 11 and withstand the normal operating conditions of the body 11. For example, the foldable sign may be constructed of a coated cardboard, wood-like, metallic or other similar material.

The body 11 of the foldable sign 10 is not limited to the rectangular shape shown in FIGS. 1-4 including the first and second edges 11a, 11b and the top and bottom edges 10a, 10b. The body 11 may take on nearly any shape, for example, square, circular, oblong, elliptical or nearly any other like shape that is able to be constructed using the above-described materials of the foldable sign and is able to withstand the normal operating conditions of the foldable sign 10. The body 11 may take on the shape of nearly any object, for example, a car, a tree, a flower or other like shape that may provide a visual indication to a user identifying what the foldable sign 10 is representing.

In the preferred embodiments, the body 11 is constructed of a polyethylene or polypropylene sheet material. The polyethylene and polypropylene sheet materials are preferred because of their durability, manufacturability, light weight, adaptability to colors and relatively high strength. The polypropylene and polyethylene materials are also preferred because they are able to take on numerous and often vibrant colors to capture a user's attention. The color of the body 11 may be used as an indication or signal to an observer. For example, the body 11 may be constructed of a bright red, octagonal polyethylene or polypropylene sheet material to represent a signal to stop. Further, a circular, green body 11 may be utilized to signal go. The foldable sign 10 may be utilized as a signaling device in numerous applications including military, construction, aviation, large event entertainment, safety and/or like signaling applications as would be obvious to one having ordinary skill in the art. The polyethylene and polypropylene sheet foldable sign 10 is particularly suited to these type of signaling applications because of its ability to take on vibrant colors that are useful for signaling, its durability and strength.

The foldable sign 10 preferably includes a handle or handle hole 12a proximate the first edge 11a and a second handle or handle hole 12b proximate the second edge 11b. In the preferred embodiments, the handle holes 12a, 12b have a generally elongated, oval-shape and are comprised of holes cut in the body 11 proximate a mid-portion of the first and second edges 11a, 11b. The first and second handle holes 12a, 12b are preferably located on opposite sides of the body 11 relative to each other and proximate the first and second edges 11a, 11b. In the preferred embodiments, the handle holes 12a, 12b are cut or punched from the body 11 after the body 11 is formed, but are not so limited. In addition, the handle holes 12a, 12b are not limited to an elongated, oval-shape and may take on nearly any shape that is typically able to accept at least a portion of a user's hand 20 comprised of at least a portion of one finger of the hand 20. The handle holes 12a, 12b are preferably large enough to accept the four fingers of a user's hand 20, as is shown in FIG. 2, but are not so limited. The foldable sign 10 is not limited to the inclusion of only the first and second handles 12a, 12b and may include additional handles as would be appropriate for a particular application of the foldable sign 10. Further, the foldable sign 10 is not limited to the inclusion of the handle holes 12a, 12b shown in FIGS. 1-4 and may be comprised of handles or straps (not shown) that extend from the first and second edges 11a, 11b for manipulating the sign 10, the construction of which would be obvious to one having ordinary skill in the art. In addition, the foldable sign 10 is not limited to the inclusion of the handles 12a, 12b at all and may be manipulated by a user without the inclusion of the first and second handles 12a, 12b, as would be obvious to one having ordinary skill in the art.

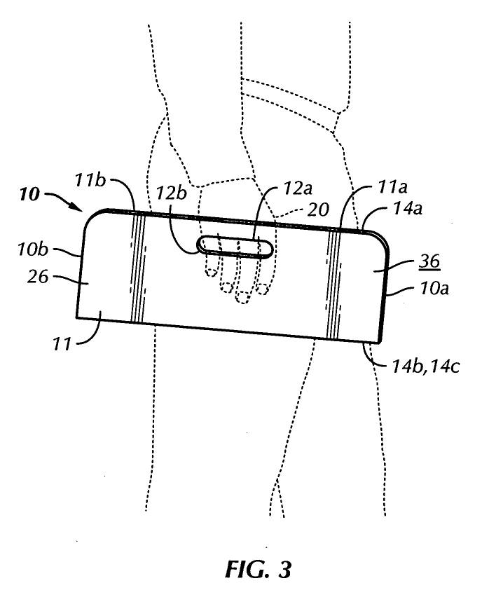

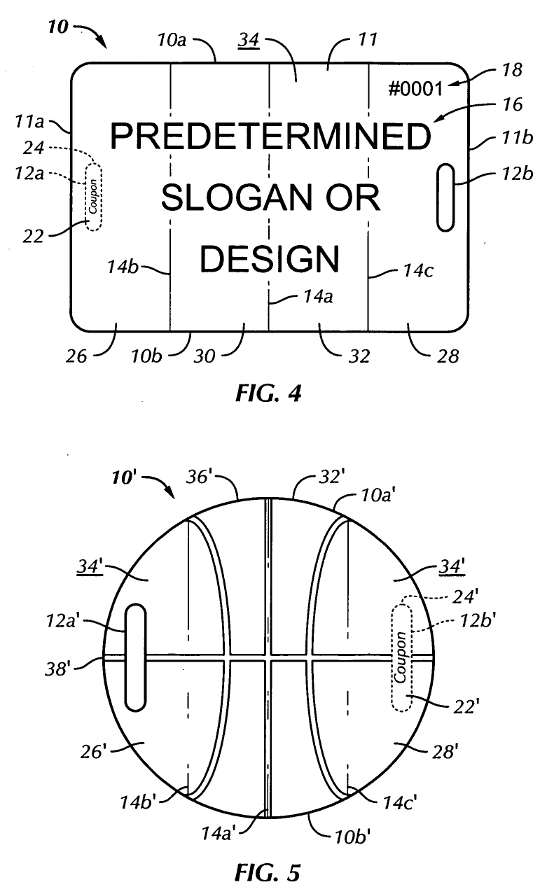

The foldable sign 10 also includes at least one fold line 14 in the body located between the first and second handle holes 12a, 12b. The fold line 14 is preferably integral with the body 11 and the body 11 is foldable along the fold line 14 between a storage position (FIG. 3) and an operating position (FIGS. 2 and 4). The first edge 12a is positioned proximate the second edge 12b in the storage position. Preferably, the first and second handle holes 12a, 12b are aligned in the storage position and the user is able to grasp the body 11 using one hand 20 to transport the sign. Alternatively, the user may insert the fingers of their hand 20 through the handle holes 12a, 12b and displace a mid-portion of the body 11 for transporting the sign 10 using the handle holes 12a, 12b. The foldable sign 10 is not limited to the first and second edges 11a, 11b aligning in the storage position. In addition, the first and second handle holes 12a, 12b are not necessarily aligned in the storage position, however, alignment of the handle holes 12a, 12b is preferred.

Referring to FIG. 4, in the preferred embodiments, the foldable sign 10 also includes a punch tab 22 positioned within the first and/or second handle holes 12a. The punch tab 22 is preferably mounted to the body 11 by a perforation 24 at the periphery of the punch tab 22. The punch tab 22 may be comprised of a coupon 22 that may be redeemed by a user following use of the foldable sign 10, typically for marketing purposes but is not so limited. The punch tab or coupon 22 is preferably integrally molded with the body 11 and is positioned within one of the first or second handle holes 12a, 12b until a user removes the punch tab or coupon 22 at the perforation 24 to form the first or second handle hole 12a, 12b. The foldable sign 10 is not limited to the inclusion of the punch tab or coupon 22 and is not limited to a single punch tab or coupon 22 located in the first or second handle holes 12a, 12b. For example, the handle holes 12a, 12b may be integrally formed in the body 11 and the punch tab 22 may be formed on a separate portion of the body 11 having nearly any shape or size, for example, a generally rectangular shape adjacent a corner of the body 11. The punch tab 22 may also be comprised of a playing card or other collectible that may be removed and saved by a collector or may be comprised of nearly any other marketing, collectible or other portion that is removable from the body 11 for later use by a consumer as would be obvious to one having ordinary skill in the art.

Referring to FIG. 1, in the preferred embodiments, the foldable sign 10 may also include a lot number 18 on the body 11. The lot number 18 preferably identifies the authenticity, origin and/or originality of the sign 10. The lot number 18 may be located on the punch tab 22 or elsewhere on the body 11. The sign 10 is not limited to the inclusion of the lot number 11 and performs its intended function without inclusion of the lot number 18. However, the lot number 18 is preferred to identify the originality and/or uniqueness of the sign 10. For example, the lot number 18 may identify specific features of the sign to a collector. The lot number 18 is preferably stamped or embossed on the body 11 to identify the specific foldable sign 10. The lot number 18 is not limited to being stamped or embossed on the body 11 and may be integrally molded or otherwise formed on the body 11 as long as the lot number 18 provides an identification of the sign 10

Referring to FIGS. 1-4 in the first preferred embodiment, the body 11 includes the top and bottom edges 10a, 10b and the first and second edges 11a, 11b. The first handle 12a is preferably positioned proximate a mid-portion of the first edge 11a and the second handle 12b is preferably positioned proximate a mid-portion of the second edge 11b opposite the first handle 12a. Positioning the first and second handles 12a, 12b in this manner permits a user to open the foldable sign 10 by applying a force F away from the body 11 at the handles 12a, 12b. The force F is preferably applied by the user's hand 20 to convert the sign 10 from the storage to the operating position. The generally high durability and strength of the polymeric sheet material of the body 11 permits a relatively large force F to be applied to the body 11 without breaking the handles 12a, 12b or the body 11 in the preferred embodiments.

The handles 12 are preferably positioned proximate the edges 11a, 11b, which are preferably parallel to the fold lines 14 that extend across the foldable sign 10. The handles 12 are preferably positioned such that a user is able to pull on the handles 12 to expose surfaces 34, 36 of the foldable sign 10 by opening the foldable sign 10 at the fold lines 14. The handles 12 are not limited to the above described positions or to the inclusion of two handles 12. The handles 12 may be positioned nearly anywhere on the body 11 and there may be any number of handles 12. However, the pair of handles 12 positioned adjacent the edges 11a, 11b of the body 11 that are generally parallel to the fold lines 14 are preferred for ease of opening the and to limit the number of handles 12 in the foldable sign 10. In addition, the foldable sign 10 is not limited to the inclusion of handles 12 and may be converted by a user from the storage position to the operating position by applying the force F to the edges 11a, 11b of the body 11 such that sign 10 opens along the fold lines 14.

In the first preferred embodiment, the at least one fold line 14 is comprised of a middle fold 14a, a first edge fold 14b and a second edge fold 14c. The middle, first edge and second edge folds 14a, 14b, 14c extend across the body 11 generally parallel to the first and second edges 11a, 11b and generally perpendicular to the top and bottom edges 10a, 10b. Constructing the folds 14a, 14b, 14c in this manner permits relatively simple folding of the foldable sign 10 between the operating and storage positions. In the storage position, the foldable sign 10 is generally compact and easy for a user to transport. In addition, the use of the polymeric sheet material for the foldable sign 10 permits relatively easy forming of the fold lines 14a, 14b, 14c on the body 11. The foldable sign 10 is not limited to the inclusion of the middle, first edge and second edge folds 14a, 14b, 14c that are oriented as is described above and may be constructed of nearly any number of folds such that the user is able to move the foldable sign 10 between the storage and operating positions. For example, the foldable sign 10 may include a single middle fold that preferably folds the sign 10 in half in the storage position.

In the first preferred embodiment, corners of the body 11 are rounded where the top, bottom, first and second edges 10a, 10b, 11a, 11b meet. Specifically, the corners are rounded such that the foldable sign 10 generally does not include sharp corners or edges that may scratch or poke a user during operation. However, the foldable sign 10 is not limited to the inclusion of rounded corners and may have nearly any type of shape at its corners.

In the preferred embodiments, the fold lines 14a, 14b, 14c are constructed of living hinges in the body 11. The living hinge fold lines 14a, 14b, 14c generally reduce the complication of the construction of the foldable sign 10 as the living hinges may be integrally formed in the body 11. Specifically, the polymeric sheet materials of the body 11 generally result in a highly durable foldable sign 10 that may be transported by a user without excessive caution or care. The living hinges are typically simple to form using the preferred polymeric sheet material of the body 11. In addition, the polymeric living hinges forming the preferred fold lines 14a, 14b, 14c may typically be flexed and/or folded innumerable times without cracking or failing. However, the foldable sign 10 is not limited to the inclusion of living hinges to form the fold lines 14a, 14b, 14c and may be constructed of mechanical hinges or other devices that permit the foldable sign 10 to be moved to the operating and storage positions.

The living hinge fold lines 14a, 14b, 14c of the preferred embodiments are preferably formed in the material of the body 11. For example, the foldable sign 10 may include a single middle fold line 14a extending across the body that is constructed of a depression in the body 11.

Referring to FIGS. 2 and 4, in the preferred embodiments the foldable sign 10 includes a first face 34 and a second face 36. The first face 34 preferably includes a slogan 16 that is exposed in the operating position. The slogan 16 of the preferred embodiments is preferably comprised of a decorative logo or other indicator that is printed on at least the first face 34. The slogan 16 may be comprised of a printing, silk screening, hot stamping or embossing that places the slogan 16 on the body 11. The foldable sign 10 is not limited to the inclusion of the slogan 16 or the above-listed types and methods of forming the slogan 16. For example, as was described above, the color of the material of the body 11 itself may be utilized to provide an indication to a user. However, printing or forming the slogan 16 on one of the faces 34, 36 of the foldable sign 10 is preferred due to its variability and adaptability to place nearly any type of slogan 16 onto the foldable sign 10.

In the preferred embodiments, the slogan 16 is printed onto a surface of either the first or second faces 34, 36 of the body 11 using an ultraviolet (UV) resistant ink that is used to reduce or eliminate scratching, UV damage and/or water damage to the slogan 16. However, the foldable sign 10 is not limited to the inclusion of UV inks and may utilize nearly any ink or any other process or material that is able to emboss the slogan 16 onto the body 11. For example, as was described above, the color of the material of the body 11 may be utilized to provide an indication to a user. However, printing the slogan 16 onto the body 11 is preferred due to its variability and adaptability to place nearly any type of slogan 16 onto the body 11.

In the preferred embodiments, in the storage position, a portion of the first face 34 is in facing engagement with a second portion of the first face 34. Placing the portions of the first face 34 into facing engagement in the storage position provides a generally compact storage position for the sign 10.

In the preferred embodiments, the slogan 16 may be comprised of nearly any visual indication to a user. For example, the slogan 16 may be a trade name of an advertiser or an indication for an observer to perform a specified task. In addition, the slogan 16 may be utilized along with the shape of the body 11 to convey a predetermined message to an observer.

Referring to FIG. 5, a second preferred embodiment of the foldable sign 10′ is depicted. The second preferred embodiment of the foldable sign 10′ is constructed and typically operates in a manner similar to the above-described first preferred embodiment. The second preferred embodiment of the foldable sign 10′ is described utilizing like reference numerals to indicate like elements and a prime symbol (′) to indicate the components of the second preferred embodiment.

In the second preferred embodiment, the body 11′ has a generally circular shape. In addition, in the second preferred embodiment, the first face 34′ includes a slogan 16′ thereon having the general appearance of a basketball. The middle fold line 14a′ extends generally perpendicularly across the body 11′ relative to a handle line 38 that extends between the first and second handle holes 12a′, 12b′. The foldable sign 10′ of the second preferred embodiment is preferably utilized at basketball games to urge on a user's team. The slogan 16′ may be modified to provide a specific indication for the user's team.

The foldable signs 10, 10′ of the first and second preferred embodiments are not limited to the above-described rectangular and circular-shapes. The bodies 11, 11′ of the preferred foldable signs 10, 10′ may take on nearly any shape to provide an indication to an observer. For example, the bodies 11, 11′ may have the shape of a football, a political symbol such as an elephant or donkey, a car or any other shape that may provide a specific indication to a user of the sign 10, 10′.

Referring to FIGS. 1-5, the preferred foldable sign 10 is constructed by cutting nearly any shape out of a sheet of polyethylene or polypropylene sheet material into the general peripheral shape of the body 11. The slogan 16 may be printed onto the polypropylene or polyethylene sheet prior to the shape of the body 11 being cut from the sheet or after the body 11 has been cut from the sheet. The handles 12a, 12b and periphery of the body 11 are preferably cut using a hot die cutting tool with continuous edges to create a continuous smooth edge on the body and handles 12a, 12b. The creation of the body 11 and handles 12a, 12b using the heated die creates relatively soft edges that are forgiving to the grip of a user. In addition, the use of the continuous edged dies preferably eliminates the possibility of nicks or protrusions at the edges of the body 11 and handles 12a, 12b that may cut or gouge the hands 20 of a user. The punch tab or coupon 22 is also preferably formed during this step by stamping the perforation 24 at the periphery of the handle hole 12a, 12b such that the punch tab 22 is formed from the material of the body 11 and is retained in the body 11 prior to release by a user. The punch tab 22 may be punched or removed from the body 11 at a later time such that a user is able to retain the punch tab 22.

The fold lines 14 are then inserted onto the body 11 such that the foldable sign 10 may be alternatively positioned in the storage or operating positions. The fold lines 14 are preferably constructed by heating the polymeric material of the foldable sign 10 along the location of a fold line 14 and folding the body along the heated fold line 14. Heating the fold line 14 creates a permanent material change along the fold line 14 so that the fold line 14 maintains a generally flexible fold. Any number of fold lines 14 may extend across the foldable sign 10, preferably in an accordion-type fashion. The fold lines 14 may also be alternately formed, as would be obvious to one having ordinary skill in the art.

Referring to FIG. 1, the body 11 is preferably stamped or embossed with a lot number 18 that identifies the specific foldable sign 10 to a collector. The lot number 18 may identify the authenticity and/or originality of the foldable sign 10.

The foldable sign 10 is utilized by transporting the body 11 in its storage position to a place of operation. The foldable sign 10 may be inserted into a user's pocket or into a carrying case, for example, a bag or folder (not shown), for transportation where it is out of the way and generally does not interfere with the user's travel. To urge their team or send a signal to an observer, the user removes the foldable sign 10 from its storage area, grasps the handles 12a, 12b and unfolds the foldable sign 10 from the folded storage position to its unfolded operating position (FIG. 3) by application of the force F. In the operating position, the color of the foldable sign 10 and/or decorative slogan 16 are exposed to an observer. The foldable sign 10 may then be moved to its storage position by folding the foldable sign 10 along the fold lines 14. The foldable sign 10 generally does not interfere with another individual's line of sight when it is in its storage position. The foldable sign 10 is also relatively compact and simple for a user to store or transport in its storage position such that it is generally out of the way. Further, the simple movement of the foldable sign 10 to and between its storage and operating positions reduces the likelihood that an individual seated or standing next to a user of the foldable sign 10 may be hit or scratched by the foldable sign 10 as it is moved between its storage and operating positions. For example, a large, rigid sign that does not fold between storage and operating positions is more likely to hit, bump or scratch an individual seated or standing next to a user of the sign.

The foldable sign 10 is convenient for use at political conventions, political rallies, sporting events including football, basketball, baseball and auto racing, product advertising, social gatherings, corporate gatherings, organizational gatherings, home holiday signage or like events. For example, the foldable sign 10 may be convenient for a political rally to identify the candidate an individual is supporting or for a sporting event for a fan to urge their team. The foldable sign 10 may also be utilized by a marketer to display an advertisement or for a collector to remove and retain a collectible formed by the punch tab 22. In addition, the foldable sign 10 and punch tab 22 are preferably durable, transportable, relatively strong, resist degradation and may be useful as a collectible for fans, political organizations or other like users. The foldable sign 10 may further be utilized as a placemat with a restaurant menu printed on the first face 34 and nearly any other slogan or design printed on the second face 36. The foldable sign 10, which is utilized as a placemat for a restaurant could be utilized as a giveaway for the restaurant as a promotion or a marketing tool. The preferred polyethylene or polypropylene sheet material of the body 11 is particularly suited for use as a placemat due to its durability, strength, ability to be cleaned relatively easily and its generally flat or planar configuration in the operating position. In addition, the foldable sign 10, when utilized as a placemat, is relatively simple for a user to arrange in the storage position such that the sign 10 may be transported from the restaurant as a give-away.

Referring to FIG. 5, in the second preferred embodiment, the foldable sign 10′ is typically, constructed and operated in a similar manner to the foldable sign 10 of the first preferred embodiment as will be obvious to one having ordinary skill in the art. The body 11′ is specifically formed into the shape of a basketball and the slogan 16′ is printed on the first face 34′ such that the foldable sign 10′ has the appearance of a basketball when viewed from the first face 34′ in the operating position. The foldable sign 10′ of the second preferred embodiment is specifically designed for use at a basketball game to urge on one's team. The punch tab 22 may be comprised of a coupon 22 or a player's collectible playing card 22. In addition, a second face (not shown) of the body 11 may be printed with an advertisers slogan 16′ or may be blank. One having ordinary skill in the art will recognize that the body 11, 11′ is not limited to the generally rectangular and circular shapes, which were described above and may take on nearly any shape that provides an indication to an observer depending upon the intended use of the sign 10, 10′.

It will be appreciated by those skilled in the art that changes could be made to the embodiments described above without departing from the broad inventive concept thereof. For example the body 11, 11′ may be formed into nearly any number of shapes and sizes to provide an indication to the observer. It is understood, therefore, that this invention is not limited to the particular embodiments disclosed, but it is intended to cover modifications within the spirit and scope of the present invention.

1. A foldable sign for providing a visual indication to an observer comprising:
a body having a first edge and a second edge opposite the first edge;
a first handle hole proximate the first edge;
a second handle hole proximate the second edge; and
at least one fold line in the body between the first and second handle holes, the fold line being integral with the body, the body being foldable along the fold line between a storage position and an operating position, the first handle hole generally aligned with the second handle hole in the storage position.

2. The foldable sign of claim 1 further comprising:
an punch tab positioned within one of the first handle hole and the second handle hole.

3. The foldable sign of claim 2 wherein the punch tab is mounted to the body by a perforation at the periphery of the punch tab.

4. The foldable sign of claim 2 wherein punch tab is comprised of a coupon.

5. The foldable sign of claim 2 further comprising:
a lot number on the body, whereby the lot number identifies one of the authenticity, origin and originality of the sign.

6. The foldable sign of claim 1 wherein the body is constructed of one of a polyethylene material and a polypropylene material.

7. The foldable sign of claim 1 wherein the body further includes a top edge and a bottom edge positioned between the first and second edges, the first handle hole positioned proximate a mid-portion of the first edge and the second handle hole positioned proximate a mid-portion of the second edge.

8. The foldable sign of claim 7 wherein the at least one fold line is comprised of a middle fold, a first edge fold and a second edge fold, the middle, first edge and second edge folds extending across the body generally parallel to the first and second edges and generally perpendicular to the top and bottom edges.

9. The foldable sign of claim 7 wherein the middle, first edge fold and second edge fold divide the body into a first handle portion, a second handle portion, a first middle portion and a second middle portion, in the storage position, the first handle portion, second handle portion, first middle portion and second middle portion defining a common periphery.

10. The foldable sign of claim 7 wherein corners of the body are rounded where the first, second, top and bottom edges meet, respectively.

11. The foldable sign of claim 1 wherein the first and edges are aligned in the storage position to provide a generally compact sign such that the sign is relatively simple for a user to transport in the storage position.

12. The foldable sign of claim 1 wherein the at least one fold is comprised of a living hinge in the body.

13. The foldable sign of claim 1 wherein the body has a generally circular-shape.

14. The foldable sign of claim 13 further comprising:
a slogan on the body, the slogan having the general appearance of a basketball.

15. The foldable sign of claim 13 wherein the at least one fold line extends generally perpendicularly across the body relative to a handle line, the handle line extending between the first and second handle holes.

16. The foldable sign of claim 1 wherein the body includes a first face and a second face, the first face including a slogan thereon, the slogan being exposed in the operating position.

17. The foldable sign of claim 16 wherein the slogan is hidden in the storage position, a first portion of the first face being in facing engagement with a second portion of the first face in the storage position.

18. The foldable sign of claim 16 wherein the slogan is printed onto the body with an ultraviolet ink that typically reduces scratching, ultraviolet and water damage to the slogan.

19. The foldable sign of claim 1 wherein the sign moves from the storage position to the operating position by grasping the first and second handle holes and applying an opening force away from the at least one fold line.

20. A foldable sign for providing a visual indication to an observer comprising:
a body;
a pair of handles cut in the body at opposite sides of the body;
at least one fold line in the body permitting the body to be folded over upon itself along the at least one fold line into a storage position, wherein the at least one fold line is comprised of a living hinge and the body is constructed of a polymeric material.
